(19) United States
(12) Patent Application Publication
(10) Pub. No.: US 2007/0098175 A1
(43) Pub. Date: May 3, 2007

(54) SECURITY ENABLER DEVICE AND METHOD FOR SECURING DATA COMMUNICATIONS

(75) Inventor: Daniel Jakubiec, Honolulu, HI (US)

Correspondence Address: PROCOPIO, CORY, HARGREAVES & SAVITCH LLP, 530 B STREET, SUITE 2100, SAN DIEGO, CA, 92101, US

(73) Assignee: Systech Corporation

(21) Appl. No.: 11/550,683

(22) Filed: Oct. 18, 2006

Related U.S. Application Data
(60) Provisional application No. 60/731,735, filed on Oct. 31, 2005.

(51) Int. Cl. H04L 9/00

(52) U.S. Cl. 380/277

(57) ABSTRACT

A security enabler device has a key management module adapted to generate and store security keys and to destroy the generated keys if necessary to protect security. An encryption and authentication module is linked to the data storage module and is adapted to use the security keys to provide secure network communications for a terminal device connected to or incorporated in the security enabler device. The key management module operates in conjunction with an operating code module to prevent access to at least one of the security keys from outside the security enabler device.

### RELATED APPLICATION

The present application claims the benefit of United States provisional patent application serial number 60/731,735 entitled SECURITY ENABLER DEVICE FOR SECURING DATA COMMUNICATIONS, filed on Oct. 31, 2005, which is incorporated herein by reference in its entirety.

### BACKGROUND

1. Field of the Invention

The present invention relates generally to data encryption and is particularly concerned with security enabler or controller devices and methods for enabling transfer of sensitive data from a terminal over an insecure communication network, such as the Internet.

2. Related Art

There exist in the world today millions of computer devices whose purpose it is to transmit sensitive computer data across long distances. These devices are often called “terminal devices” and serve a variety of purposes. For example, the point-of-sale industry uses card reader terminals to submit financial transactions to remote transaction servers. These terminals transmit sensitive debit/credit card information across public and private communications networks. The banking industry uses Automated Teller Machines (ATM) to dispense cash and manage bank account information. These machines transfer sensitive financial information across public and private communications networks. Various industries implement customized computer terminals to connect field offices and other remote locations across geographically large areas. These industries transmit many kinds of sensitive information across public and private communications networks.

Prior to the general availability of the Internet and of modern Internet Protocol (IP)-based global networks, such sensitive data was usually transferred between remote locations using public telephone networks, leased phone lines, satellite connections, and other point-to-point mechanisms. In recent years, private (but not necessarily secure) IP networks have also been used for this purpose. These mechanisms have provided some level of security for the sensitive data primarily due to their point-to-point and/or private nature. But by today's standards, these communication networks are generally both expensive and slow.

Today, the public Internet provides a much cheaper and faster way for people to transmit data between geographically remote areas. Many businesses that currently rely on terminal devices to transmit sensitive data across older point-to-point and/or private mediums would like to replace these communications paths with public IP-based networks, such as transmission control/Internet Protocol (TCP/IP)-based networks or other IP networks in the Internet Protocol suite. Unfortunately, there are two big barriers to making such a transition: 1) Many legacy devices or older terminal devices do not contain the necessary IP-based network hardware or software to communicate across these modern networks; and 2) Most legacy devices do not support the modern network security mechanisms necessary for transmitting sensitive data across public networks in a safe and secure manner.

Modern network security is accomplished using a set of cryptographic technologies collectively known as “public key cryptography”. However, network security has traditionally been (and continues to be) a highly complicated science. Although the details of public key cryptography are widely available in the public domain, the primary challenge in using these technologies effectively is in their practical implementation.

Public key cryptography requires that each computer device participating in secure communications secretly store a private security “key”. This “private key” uniquely identifies the computer device and is used for authentication and encryption purposes. As long as this private key remains private, security can be ensured. Each private key has a unique companion key known as a “public key”. The public key is meant to be freely distributed and does not need to remain secret. It is used by peer devices to decrypt data encrypted with the private key. Together, the public key and private key form what is called a “certificate”.

The security of a given set of devices is largely determined by the quality of the key management approach. The conventional approach to public/private key pair management requires several complex and difficult steps which must be performed for each network device which is to be involved in secure network communications:
1. The end-user obtains certificate generation tools and loads them onto a personal computer.
2. The end-user generates a Certificate Signing Request (or CSR) describing the public and private key which is to be created.
3. The end-user submits the CSR to a Certifying Authority for digital signing, or self-signs the CSR themselves.
4. The end-user copies the certificate's public and private keys from the personal computer and onto the network device which they are meant to identify. Since the device is not yet secured, this occurs via non-secure mechanisms (such as email or non-secure networks) which can compromise the secrecy of the private key.
5. The end-user copies the certificate's public key to the remote server which will be accessed by the network device. This enables the server to identify the network device (which holds the corresponding private key) as a trusted device.
6. The end-user implements and enforces security policies to keep all copies of the private key secure forever.

The biggest weakness of the conventional approach to key management is the handling of the private keys. In the conventional approach, private keys must be created under highly controlled conditions, and must be distributed to network devices spread out over large geographical areas without compromising their secrecy. They are usually delivered to their target devices using insecure mechanism, such as personal computers and email (which are rarely secured themselves). They are often handled by human installers who can make mistakes that compromise key security. Furthermore, all copies of these private keys must be forever protected against attacks by malicious parties. This includes the original copy of the private key, any copies made while transmitting the key to the target device, and also the final copy which must remain on the network device itself.

In general, implementing modem security technologies is a very tricky business. Various aspects of network security are both difficult to understand and difficult to implement in practice. Well-trained computer and security experts can often assemble, scrutinize, and maintain end-to-end networks that provide solid security for transmitting sensitive data. But such abilities are often beyond the reach of the typical end-user trying to secure their sensitive data transmissions.

Therefore, what is needed is a system and method that overcomes these significant problems found in the conventional systems as described above.

### SUMMARY

A security enabler device for secure network communications in one embodiment has a key management module adapted to generate security keys and to destroy the generated keys if necessary to protect security. A data storage module stores the generated security keys. An encryption and authentication module is linked to the data storage module and is adapted to use the security keys to encrypt data to be transmitted from the security controller device over a network and to decrypt data received from a remote host over the network. A network interface is provided for communicating with a network to transport secured data from the device to the network and from the network to the device. The key management module operates in conjunction with an operating code module to prevent access to at least one of the security keys from outside the controller device.

In one embodiment, the security enabler device has one or more terminal interfaces for connection to one or more user terminal devices which may be legacy, non-Internet Protocol (IP) devices. Each non-IP interface is connected to a terminal protocol converter module for converting data received from the terminal for transmission over a network into the appropriate network protocol prior to encryption, and for converting data received over the network into the appropriate terminal protocol before sending the converted data to the user terminal device. The security enabler device in this embodiment enables non-secure, legacy terminal devices to securely transmit and receive sensitive data over modem public networks such as the Internet. In this embodiment, the security enabler device may also have IP input interfaces for connection to IP enabled user terminals. The security enabler device is a computer device which can be connected to user terminal devices to enable the terminal devices to securely transmit sensitive data across modem networks. The user terminal devices may be card reader terminals, automated teller machines (ATMs) or computer terminals in any industry which must transmit and receive sensitive data over public and private networks.

In one embodiment, the key management module is configured to detect digital signatures associated with any new operating code which a user attempts to install via a user update request, and to verify the nature and origin of the new operating code before replacing the original operating code. If no authorized digital signature is detected, the update request is refused. In one embodiment, the system allows for two different authorized digital signatures. A secure digital signature is associated with operating code which completely restricts access to a private key of the stored security keys. A safe digital signature is associated with operating code which is signature protected but which does not necessarily restrict access to an existing private key. In the latter case, on detection of a safe digital signature, the key management module is configured to destroy the stored security keys before updating the operating code.

Other features and advantages of the present invention will become more readily apparent to those of ordinary skill in the art after reviewing the following detailed description and accompanying drawings.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 is a block diagram illustrating an example of a computer network environment in which a security enabler device according to an embodiment of the invention is deployed;

FIG. 2 is a flow chart illustrating an embodiment of a secure communication method carried out by the security enabler device of FIG. 1; and

FIG. 3 is a flow chart similar to FIG. 2 illustrating another embodiment of the secure communication method.

### DETAILED DESCRIPTION

Certain embodiments as disclosed herein provide for computer security devices and methods for enabling non-secure terminal devices to transmit sensitive data securely across modern networks. For example, one device and method as disclosed herein implements several public security technologies to secure data transmissions from both Internet protocol (IP) and non-IP terminal devices.

After reading this description it will become apparent to one skilled in the art how to implement the invention in various alternative embodiments and alternative applications. However, although various embodiments of the present invention will be described herein, it is understood that these embodiments are presented by way of example only, and not limitation. As such, this detailed description of various alternative embodiments should not be construed to limit the scope or breadth of the present invention as set forth in the appended claims.

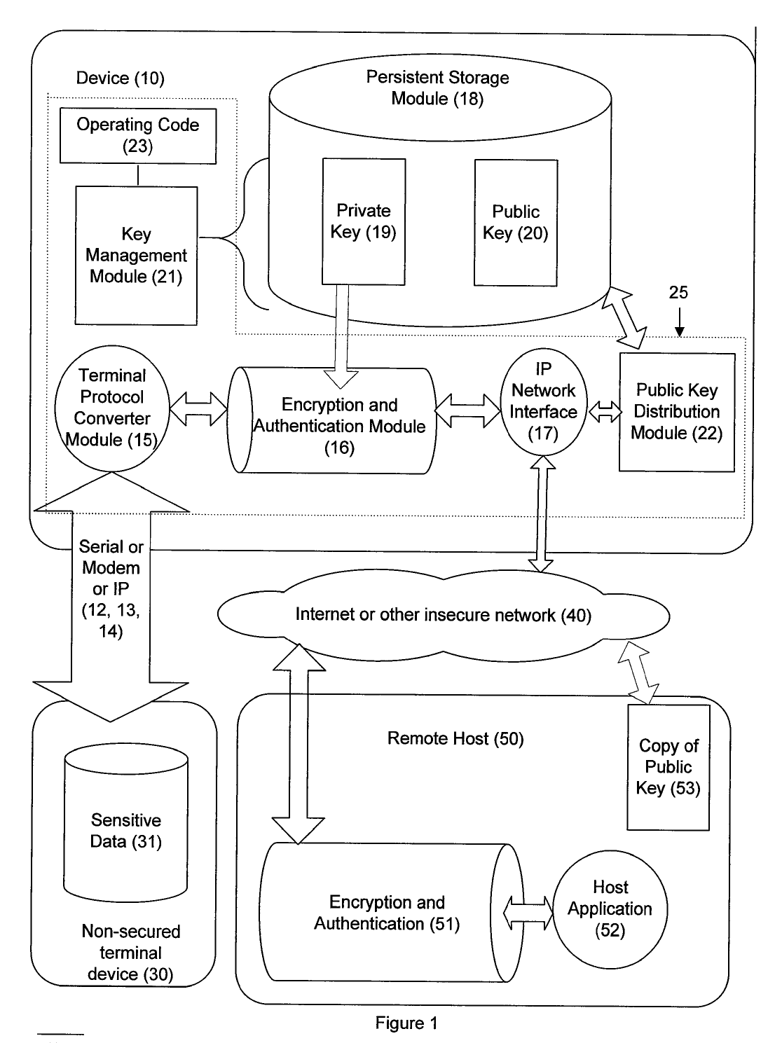

FIG. 1 illustrates a network environment in which a security enabler device or system unit 10 according to one embodiment is deployed between a non-secure terminal device 30 and a network connection 17 to a non-secure network such as the Internet. Non-secure terminal device 30 contains sensitive data 31 which it needs to transmit to host application 52 running on remote host 50. Terminal device 30 may be a legacy device or any other non-secure device, and may be an IP or non-IP terminal device. Host application 52 likewise needs to send responses containing sensitive data back to terminal device 30. Sensitive data is transmitted back and forth between terminal device 30 and remote host 50 over network 40 which is not secure, using security enabler device or computer security device 10 to enable secure communications.

In the illustrated embodiment, the non-secure terminal device is separate from computer security device 10 and is connected to the device by one or more interfaces 12,13,14 as described in more detail below. In this case, device 10 may be a modular unit which can be connected between one or more non-secure terminal devices and a non-secure network. In alternative embodiments, the functions of terminal device 30 are implemented directly in security device 10, eliminating the need for interfaces 12,13,14. In another alternative embodiment, security device 10 is implemented in a modular communication server such as the server described in U.S. patent application Ser. No. 10/993,226 filed Nov. 19, 2004, entitled MODULAR COMMUNICATION SERVER, the contents of which are incorporated herein by reference in their entirety. Thus, security device 10 may be a stand-alone computer unit or may be combined with a terminal device or a network communication server.

Remote host 50 includes public encryption and authentication software module 51. However, terminal device 30 does not support the necessary encryption and authentication protocols, and it may even lack the ability to communicate directly via the IP network 40. Security enabler device 10 provides IP network connection ability as well as security for communications between the terminal device 30 and a remote host over a network. As illustrated in FIG. 1, security enabler device 10 has a plurality of different interfaces or input/output devices 12,13,14 providing different types of standard connections to terminal devices 30, a terminal protocol converter module 15 connected to the interfaces 12,13,14, an encryption and authentication module 16 connected to the terminal protocol converter module 15, and one or more IP network interfaces 17, such as Ethernet interfaces, point-to-point protocol (PPP) interfaces, or the like, connected to the encryption and authentication module 16 and providing for connection to a non-secure network 40 such as the Internet or other public or private networks which are non-secure.

In one embodiment, as indicated by the dotted line enclosure 25 in FIG. 1, modules 15, 16, 17, 21, 22 and 23 may be implemented as hardware, software, firmware, or combinations thereof running on a processor 25.

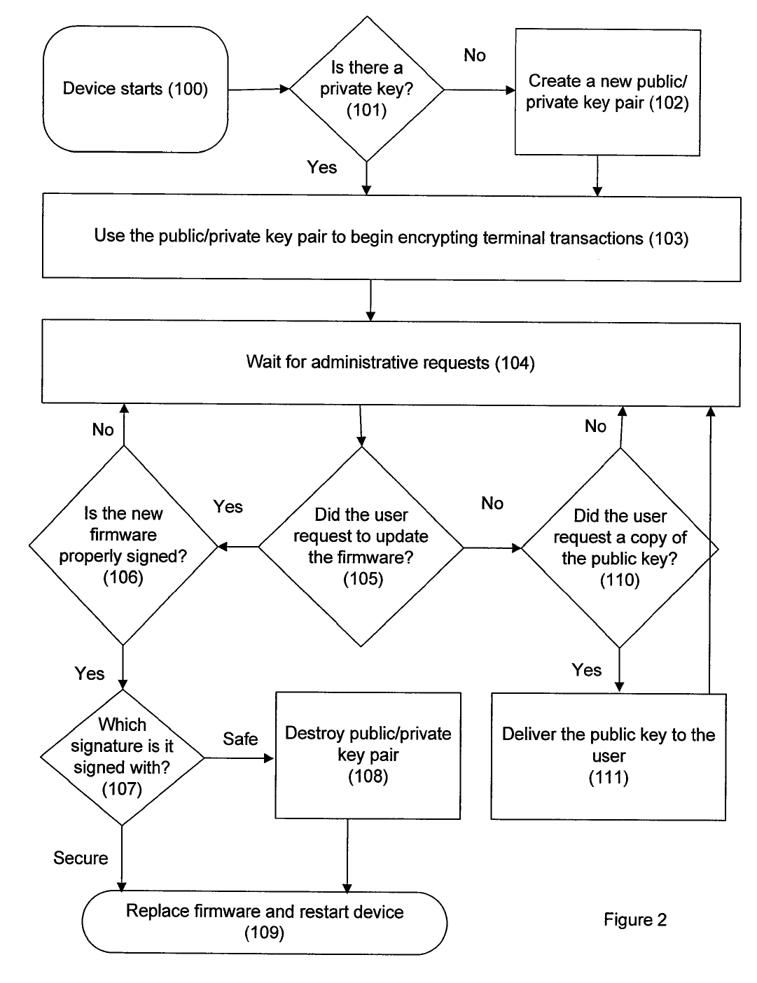

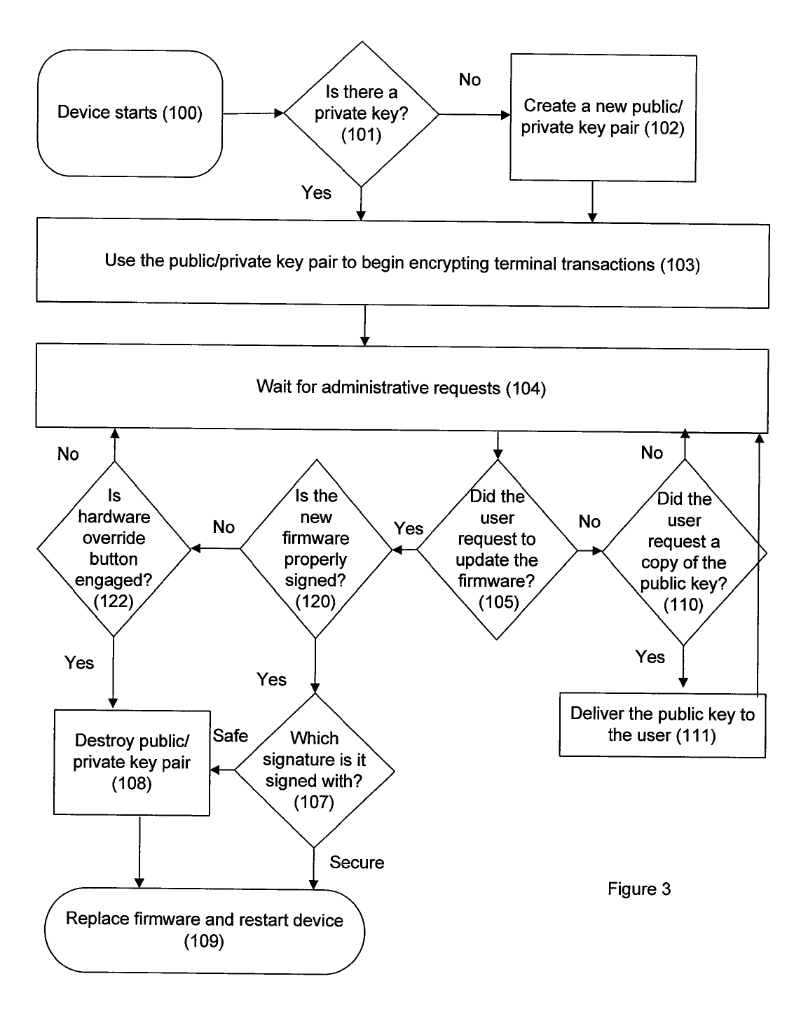

A persistent data storage module 18, such as a flash random-access memory (RAM), file system, or the like, is connected to the encryption and authentication module 16 and contains a private key 19 used for authentication and encryption and a public key 20 corresponding to key 19. A public key distribution module 22 provides a mechanism for distributing public key 20 over network 40. Key management module 21 provides an algorithm for generation and protection of the private key 19 and public key 20. The security enabling device or unit 10 also has an operating code module 23 associated with the key management module 21. The operating code in module 23 is written to limit access to the internal modules of the device 10 via the interfaces 12,13,14 and 17, to protect the operating code from being arbitrarily updated by a new operating code, and to destroy the private key 19 when necessary to protect its secrecy, as described in more detail below in connection with FIG. 2 and FIG. 3. Operating code module 23 contains all the computer instructions for operating the security device 10. It is possible to devise new operating code (maliciously or otherwise) which subverts or removes key management module 21. Loading such code onto the security enabler 10 would compromise the security of private key 19 stored within persistent storage 18. To protect against loading of such non-secure or malicious operating code, the key management module 21 incorporates digital signing techniques to verify the nature and origin of any new operating code. Depending on the results of the digital signature verification, in one embodiment the update request might be refused or the private key 19 might be destroyed to protect its secrecy.

In one embodiment, the interfaces or input/output ports provided for connecting device 10 to one or more terminal devices 30 comprise serial interfaces 12, modem interfaces 13, and network interfaces 14, although only one interface type may be provided in alternative embodiments. The serial interfaces may be Recommended Standard (RS) 232 or RS-422/485 serial ports, Universal Serial Bus (USB) ports, or firewire ports. One or more parallel ports may also be provided. The modem interfaces 13 may comprise one or more plain-old-telephone service (POTS) phone jacks with internal modems to emulate the dial tones and functionality provided by a typical phone company and call center, or any other type of modem interface. The network interfaces 14 may comprise one or more IP based interfaces to allow connection to data terminal devices 30 which are IP enabled but which require the security mechanisms provided by device 10. The IP interfaces support various Internet Protocol versions, and in one embodiment Internet Protocol version 4 (IPv4) and Internet Protocol version 6 (IPv6) are supported.

In one embodiment, the device 10 has one or more network interfaces 17 such as Ethernet-based network interfaces or Point to Point Protocol (PPP) interfaces which connect to public IP based networks such as the Internet.

The terminal protocol converter module 15 accepts serial, modem, and network data from non-secured terminal devices 30 in a number of terminal-specific formats, and is configured with protocol conversion logic to convert the data from the terminal devices into the appropriate IP network protocols required by the remote host 50 and host application 52, such as IPv4, IPv6, or other protocols in the Internet Protocol suite. The protocol conversion logic or software in converter module 15 is also arranged to convert data in network protocol received from the remote host back into the terminal-specific format required by the terminal device 30 before transmitting the data to device 30.

The encryption and authentication module 16 in one embodiment is publicly available authentication and encryption software, such as Open Secure Socket Layer (OpenSSL) software. This module is configured to encrypt network protocol data received from converter module 15 based on the private key 19 and public key 20 in storage module 18, and to transmit the encrypted data via interface 17 over the network 40 to the encryption and authentication module 51 of remote host 50.

In one embodiment the security enabler device 10 is implemented in the modular communication server described in U.S. patent application Ser. No. 10/993,226, filed Nov. 19, 2004, entitled MODULAR COMMUNICATION SERVER; the contents of which are hereby incorporated by reference. Being a flexible computer device, the security enabler device 10 also includes the ability to update its operating code 23 via TCP/IP network interface 17. Such a mechanism is useful for fixing bugs and incorporating future enhancements.

In order to operate the security enabler device 10, the owner of terminal device 30 connects it to device 10 using one of the supported hardware interfaces 12, 13, or 14. Device 10 is connected to TCP/IP network 40 via TCP/IP interface 17. This provides access to remote host 50.

When security enabler device 10 is powered on, it prepares the private key 19 and public key 20 using the key management module 21, as described below in connection with FIG. 2. These security keys are used with the encryption/authentication software or module 16. In one embodiment, the security enabler 10 has no factory-programmed security keys. All security keys are created at run time using module 21.

To enable authenticated and encrypted communication between security enabler device 10 and remote host 50, public key cryptography requires that remote host 50 obtain a copy of public key 20. This action usually occurs once whenever a new private/public key pair is created by security enabler device 10. Security enabler device 10 includes an integrated, network-based public key distribution module 22 for delivering a copy of public key 20 to remote host 50. This module 22 is manually initiated by the end user (as described below) and has the effect of registering security enabler device 10 with remote host 50.

In one embodiment, key management module 21, in conjunction with features provided by operating code module 23, never allows the private key to exist outside of the security enabler device 10. In this embodiment, the operating code module 23 is configured to limit access to the internal memory and storage of security device 10. In one embodiment, interfaces 12, 13, 14, and 17 are the only interfaces available between the external environment and the security device 10. The operation of all of the external interfaces is governed completely by operating code module 23. The operating code module 23 secures these interfaces in such a way as to disallow any access to private key 19. This includes, but is not limited to, operations such as memory dumps, data dumps, debug logging, data transfers, and the like.

Since all of the private key protections described above are implemented by operating code module 23, the operating code itself is protected from being replaced with malicious operating code. If operating code in module 23 were replaced with different code which removes any of these protections, the private key 19 stored in persistent storage 18 could then be compromised. Operating code module 23 may only be updated via interfaces 12, 13, 14, and 17. Since operating code module 23 completely governs these interfaces, it also completely governs any updates to itself which may be requested by an end user. Prior to allowing itself to be replaced with new operating code, operating code module 23 uses digital signature verification to verify that the new operating code originated from a trusted source. The trusted developer of the new operating code is expected to sign only such operating code which implements the necessary security protections described in the following paragraphs.

Key management module 21 makes a distinction between two classes of acceptable operating code. “Secure” operating code is operating code that implements key management module 21 and completely restricts access to private key 19. “Safe” operating code is operating code that implements digital signature protection, but does not necessarily implement the other protections so far described. In one embodiment, these two classes of operating code are distinguished using two different digital signatures.

When operating code module 23 receives a request to update to new operating code which is signed with the “secure” signature, the private key 19 is retained in persistent storage 18. In this case, the new operating code is expected to maintain the protections provided by key management module 21, so private key 19 remains secure. When the security enabler device receives a request to update to a new operating code which has been signed with the “safe” signature, the private key 19 is destroyed prior to updating the operating code. The new operating code continues to verify signatures on operating code updates, but no longer guarantees the security of private key 19.

Key management module 21 does not allow the operating code to be replaced with new operating code which is not properly signed. This protects against malicious code which could be loaded to compromise system security.

Key management module 21 is not limited to one safe signature and one secure signature. Multiple “safe” digital signatures and multiple “secure” digital signatures may be used in conjunction with key management module 21 in a similar manner. This allows for operating code to originate from more than one trusted source while still maintaining the same semantics for each of the two classes of signatures.

FIG. 2 is a flow chart of a process which creates private security keys 19 and maintains their privacy. In one embodiment, the process depicted in FIG. 2 can be implemented by the key management module 21 shown in FIG. 1. When the security enabler device 10 is powered on, it begins in state 100. In step 101, the contents of persistent storage module 18 are checked to see if the module contains private key 19 and the corresponding public key 20. If these security keys exist, the security device 10 is in condition to begin encrypting terminal transactions, using the public/private key pair (step 103).

If a private key 19 is not found in step 101, the security device 10 creates private key 19 and the corresponding public key 20 in step 103, using standard public key cryptography techniques. It saves both keys to persistent storage module 18 to be used during the next power up sequence. Note that standard public key cryptography techniques reasonably guarantee that these security keys are unique in the world. As such, these newly generated keys can now be used to uniquely identify the security device 10 to the world. In order to create a new key pair, security device 10 determines the current date and time of day. In one embodiment, security device 10 obtains its time information from a standard IP time server via network 40 using a standard time synchronization protocol (e.g. the Network Time Protocol).

The operating code module 23 never allows the private key 19 to leave the system. All the external interfaces 12, 13, 14, 17, and 22 are expressly programmed to prevent any external entity from extracting the private key. The physical circuitry of security device 10 can also be physically secured by the end-user in any suitable manner to protect against hardware-based attacks.

In step 103, the security device 10 supplies the private key 19 to the encryption/authentication software module 16 which begins securing any data sent or received by terminal device 30 using the private key. This process continues in parallel with administrative functions which are processed starting with step 104. In step 104, the security enabler 10 waits for an administrative request from the user, such as a request to update firmware or update the operating code of the security device, or a request to deliver copies of the public key 20.

When the user issues an administrative request to security enabler device 10, it is processed in step 105. If the user requests installation of new firmware or operating code in step 105, the security device first determines whether the new operating code is properly signed (step 106). In step 106, the digital signature of the new operating code is checked for validity. If the operating code has not been digitally signed by a valid signer, the operating code update request is refused and the security enabler 10 returns to step 104 and awaits the next administrative request. If the new operating code has been digitally signed by a valid signer, the security device 10 proceeds to step 107.

In step 107, the security device 10 determines which of two valid signatures were used to sign the operating code image. The “Safe” signature identifies trusted operating code which does not implement key management module 21. The “Secure” signature identifies trusted operating code which does implement key management module 21. If the “Safe” signature is detected, the security device 10 proceeds to step 108. If the “Secure” signature is detected, indicating that the new firmware implements the private key security of key management module 21, the security device 10 proceeds to step 109.

In step 108, a user has requested reprogramming of the security device with trusted operating code which nevertheless does not implement key management module 21. This new operating code is not able to maintain the secrecy of the private key 19. Because of this, the security device 10 destroys the sole copy of private key 19 in step 108 before replacing the operating code. The corresponding public key 20 is also destroyed, since it is not useful without private key 19. The system then proceeds to step 109.

In step 109, the security device 10 is reprogrammed with the new operating code image. The system is then re-booted to begin executing the new operating code. If the new operating code also implements key management module 21, it begins anew in step 100.

Another administrative request is a request by a user for a copy of the public key 20 (step 110), for example from a user of the remote host. On receipt of such a request, a copy 53 of the public key 20 is delivered to remote host 50 using the distribution module 22. The security device 10 then returns to step 104 to await the next administrative request.

With this system, at step 103, whenever the non-secured terminal either transmits data to a remote host or receives data from the remote host over network 40, the encryption and authentication module 16 uses the public and private keys to encrypt data before transmitting the encrypted data to remote host 50, and to decrypt data received from the remote host.

In an alternative embodiment, the security enabler device 10 provides a physical mechanism such as an override button for bypassing the digital signature protection offered by steps 106 and 107 of FIG. 2. This alternative is illustrated in FIG. 3 and described in more detail below. This is useful for situations where the end user wants to load operating code which cannot or should not be digitally signed. For example, perhaps the end user wants to reuse the security enabler's hardware platform for some other application which does not implement any of the protections offered by module 21 or operating code 23.

To implement this flexibility in a secure manner, security enabler device 10 allows an end user with physical access to the security enabler's hardware to load new, unsigned operating code by performing a physical action during the firmware update procedure. This action consists of one or more of the following detectable events: pressing an override button on the security enabler device, installing a hardware jumper, power cycling the enabler, or any other action which requires physical access to the hardware of security device 10.

In this embodiment, if a user request for updating the firmware is received (step 105), the system first determines whether the new firmware is properly signed (step 120). If it is properly signed, the security device proceeds to step 107, as in the previous embodiment, to determine which signature was used, and then proceeds to either step 109 or step 108, depending on whether the signature was secure or safe, exactly as described above in connection with FIG. 2.

If the new firmware is not properly signed, the security device determines whether the hardware override button is engaged (step 122). If not, the operating code update request is refused and the security enabler 10 returns to step 104 and awaits the next administrative request. If the hardware override button is engaged, the security device proceeds to step 108, destroying the public/private key pair, and then replaces the firmware and restarts the device (step 100).

The public key distribution module 22 of FIG. 1 is provided to help deliver the public key 20 to remote host 50 in order to create the public key copy 53. Though only one remote host is depicted in FIG. 1, more than one remote host can be used. Since the public key does not need to remain secret, any number of convenient non-secure mechanisms can be employed to deliver it. Distribution module 22 can deliver public key 20 using one or more of the following network-based transmission protocols, or any other transmission mechanism:
1. The security enabler device 10 implements an Internet-standard Hyper Text Transfer Protocol (HTTP) web server as its primary administrative interface. The end-user can use an Internet web browser to download the public key 20 from the Hypertext Markup Language (HTML) based user interface of the security enabler device.
2. The security enabler device 10 can deliver the public key 20 to remote server 50 via email using the Simple Mail Transfer Protocol (also known as SMTP).
3. The security enabler device 10 can deliver the public key 20 to remote server 50 using HTTP.
4. The security enabler device 10 can send the public key 20 to remote server 50 using any other non-secure network protocol as required by remote server 50.

In the security enabler device 10 of the above embodiments, end-users do not need to generate their own public/private keys, nor do they need to understand the key creation process. End-users do not need to obtain or learn the use of any special tools. Key generation is performed automatically inside the security enabler device. End-users also do not need to concern themselves with the security of their private keys. The operating code of the security enabler device ensures that the private key is never handled or transmitted outside of the security enabler device. The end-user does not need to create or implement any additional security policies and procedures to keep the private key secret.

In the above embodiments, each security enabler device ends up with a public and private key which uniquely identifies it. This allows access to the remote server to be controlled on a per-device basis. The security enabler device provides several integrated mechanisms to deliver the public key to the remote server. The public key can be transmitted over public networks using standard, non-secure network protocols without compromising the security of the private key.

The security enabler device 10 also integrates a number of common security mechanisms to further improve the security of the system. The identity of remote host 50 is verified by security enabler device 10 using standard public key cryptography mechanisms. The security enabler device 10 stores a list of trusted public keys in persistent storage 18. This list is configurable by the end-user. This list is used to determine whether remote host 50 should be trusted.

Internet Protocol (IP) fire walling and IP filtering technology can be implemented by the security enabler device 10 to limit network access to its user interfaces. All unnecessary network services of the security enabler device 10 can be disabled if so desired. Use of these features can reduce the number of unforeseen security holes which may exist in any computer software implementation.

In the above embodiments, the security enabler device 10 implements an HTTP web server as its primary administrative interface. This allows end-users to configure the security enabler device 10 using a standard web browser. The security enabler device 10 supports Hypertext Transfer Protocol over Secure Socket Layer (HTTPS) to secure this web browser interface. HTTPS implements public key cryptography techniques to authenticate and encrypt access to the web server. The secure HTTPS interface of the security enabler device takes advantage of key management module 21. The public/private key pair generated by module 21 is also used to authenticate the security enabler device 10 to web browser clients. Key distribution module 22 is used in a similar manner to register the security enabler device 10 with web browser clients.

The security enabler device 10 in one embodiment implements a mechanism for updating configuration information and firmware once it has been deployed into the field. The security enabler device 10 can be configured to periodically contact a configuration server to obtain firmware and configuration updates. Since most Internet-connected sites are today protected from external access by firewalls, this “call home” mechanism allows secure updates to be propagated from a central configuration server to devices which reside behind such firewalls.

In one embodiment, the security enabler device 10 provides several functional additions to the capabilities of terminal device 30:
1. It provides network connectivity for terminal device 30 to allow it to communicate via IP network 40.
2. It provides protocol conversion logic 15 to convert the terminal protocols used by terminal device 30 for transferring sensitive data 31 into the network protocols required by remote host 50 and host application 52.
3. It implements public authentication and encryption software 16 to securely transmit the network protocols to the encryption/authentication software 51 running on remote host 50.
4. It implements a key management module or algorithm 21 which securely creates and distributes the security keys necessary for encryption and authentication. The module 21 is more fully described in connection with FIG. 2.
5. The key management module 21, in conjunction with operating code 23, likewise guarantees that private key 19 can never be seen by anything external to security enabler device 10. This property of module 21 and operating code 23 provides enhanced security over conventional approaches to key creation and distribution. This is accomplished by: a) creating or writing the operating code module 23 to limit access to the internal modules of the security enabler device through interfaces 12, 13, 14, and 17; b) protecting the operating code 23 from being arbitrarily updated by new operating code; and c) destroying the private key 19 when necessary to protect its secrecy.

Those of skill will further appreciate that the various illustrative logical blocks, modules, and algorithm steps described in connection with the embodiments disclosed herein can often be implemented as electronic hardware, computer software or firmware, or combinations of both. To clearly illustrate this interchangeability of hardware and software, various illustrative components, blocks modules and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block or step is for ease of description. Specific functions or steps can be moved from one module, block or step without departing from the invention.

The various illustrative logical blocks and modules described in connection with the embodiments disclosed herein can be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly limited by nothing other than the appended claims.

1. A security enabler system for secure communication of data over a network, comprising:
a key management module configured to create security keys for use in encryption and authentication;
a storage module linked to the key management module and configured to store the security keys;
an encryption and authentication module linked to the storage module and configured to use the security keys to encrypt data to be transmitted from the security enabler device over a network and to decrypt data received from a remote host over a network;
a network interface linked to the encryption and authentication module and configured for transmitting and receiving encrypted data over a network; and
an operating code module associated with the key management module and configured to prevent access to at least one stored security key through the network interface.

2. The system of claim 1, wherein the security keys comprise a public key and a private key pair, and the operating code module is configured to prevent access to the private key from outside the system.

3. The system of claim 2, further comprising a public key distribution module associated with the network interface and configured to distribute a copy of the public key to at least one remote host to allow secure communications with the security enabler system.

4. The system of claim 1, further comprising at least one input interface for connection to a terminal device to enable secure communication between the terminal device and a remote host over a non-secure network.

5. The system of claim 4, wherein the input interface is selected from the group consisting of: Recommended Standard (RS) serial ports, Universal Serial Bus (USB) ports, firewire ports, parallel ports, phone modem interfaces, and network interfaces.

6. The system of claim 5, further comprising a terminal protocol converter module connected between the input interface and the encryption and authentication module, the terminal protocol converter module being configured to convert data received from a terminal device connected to the input interface to a predetermined network protocol and to transmit the converted data to the encryption and authentication module.

7. The system of claim 6, wherein the terminal protocol converter module is further configured to convert data received over the network and decrypted by the encryption and authentication module into the connected terminal protocol before transmitting the converted data to a connected terminal device.

8. The system of claim 1, further comprising an input terminal module configured to receive user input and a data storage module associated with the input terminal module for storage of sensitive data, the input terminal module and data storage module being linked to the encryption and authentication module for transmitting data from the data storage module to the encryption and authentication module for encryption and transmission over the network and for receiving decrypted data from the encryption and authentication module.

9. A computer readable medium having stored thereon one or more sequences of instructions for causing one or more microprocessors to perform the steps for secure transmission and receiving of data over a network, the steps comprising:
checking if a private key is stored in a persistent storage module of a security enabler device;
if no private key is found, creating a private key/public key pair and storing the key pair in the persistent storage module;
receiving input data from a user for transmission over a network to a remote host;
encrypting the data using the private key/public key pair stored in the persistent storage module;
distributing the public key to the remote host;
sending the encrypted data to the remote host over the network;
receiving data over the network from a remote host;
authenticating the remote host;
decrypting the data using the private key/public key pair; and
sending the decrypted data to the user.

10. The medium of claim 9, wherein the steps further comprise checking any new firmware update request from a user for a predetermined digital signature, and replacing the existing firmware of the security enabler device with the new firmware on detection of a digital signature indicating that the new firmware restricts access to the private key.

11. The medium of claim 10, wherein the steps further comprise destroying the private key if a digital signature associated with a new firmware does not restrict access to the private key, and replacing the existing firmware of the security enabler device with the new firmware after the private key is destroyed.

12. The medium of claim 11, further comprising the step of restarting the security enabler device after replacing the firmware.

13. A method for secure communication over network, comprising:
checking a persistent storage module of a security enabler device to determine if a private key is stored in the module each time the security enabler device is activated;
if no private key is found, creating a new public/private key pair and storing the key pair in the persistent storage module;
restricting access to the private key from outside the security enabler device; and
encrypting terminal transactions between at least one user terminal and at least one remote host linked to the security enabler device over a network using the public/private key pair.

14. The method of claim 13, further comprising checking any new firmware update request received from a user for at least one predetermined type of digital signature; and if a predetermined secure digital signature is detected, replacing the existing firmware of the security enabler device with the new firmware input by the user, the secure digital signature indicating that the new firmware restricts access to the private key.

15. The method of claim 14, further comprising refusing the update request if a predetermined digital signature is not detected.

16. The method of claim 14, further comprising the steps of destroying the public/private key pair, replacing the firmware and restarting the security enabler device if a second predetermined type of digital signature is detected, the second type of signature corresponding to firmware which does not restrict access to the private key.

17. The method of claim 14, further comprising checking whether a hardware override button is engaged if a new firmware update request is received without an associated digital signature, refusing the update request if the override button is not engaged, and destroying the public/private key pair, replacing the firmware with the new firmware, and restarting the security enabler device if the override button is engaged.

18. The method of claim 13, further comprising converting non-network protocol data received from a terminal device connected to the security enabler device into network protocol data before encrypting the data for transmission over a network using the public/private key pair.

19. The method of claim 18, further comprising converting decrypted network protocol data received from a remote host into terminal protocol data before sending the converted data to the terminal device.

20. A security enabler device for secure communication of data over a network, comprising:
a key management module configured to create a public key and private key pair for use in encryption and authentication;
an encryption and authentication module configured to use the private key to encrypt data to be transmitted from the security enabler device over a network and to decrypt data received from a remote host over a network;
a network interface linked to the encryption and authentication module and configured for transmitting and receiving encrypted data over a network; and
an operating code module associated with the key management module and configured to prevent access to the private key through the network interface.

21. The device of claim 20, wherein the key management module is configured to check whether security keys comprising a public key and private key pair are present in the device each time the device is activated, and to create a public key and private key pair if no security keys are located.
